(19) United States
(12) Patent Application Publication
(10) Pub. No.: US 2022/0267027 A1
(43) Pub. Date: Aug. 25, 2022

(54) AIRCRAFT, COMPRISING A BATTERY ASSEMBLY

(71) Applicant: Lilium eAircraft GmbH, Wessling (DE)

(72) Inventors: Andreas MÖBIUS, Munich (DE); Ryan PITRE, Wessling (DE); Angel PLAZA, Wessling (DE)

(21) Appl. No.: 17/672,168

(22) Filed: Feb. 15, 2022

(30) Foreign Application Priority Data
Feb. 19, 2021 (EP) 21158199.6

(51) Int. Cl. B64F 5/60; B64D 27/24; B64C 39/12; B64D 41/00; G01M 1/12

(52) U.S. Cl. CPC B64F 5/60; B64D 27/24; B64C 39/12; B64D 41/00; G01M 1/125; B64D 2221/00

(57) ABSTRACT

The present invention relates to an aircraft (10), comprising a fuselage (12), at least one pair of wings (14) and a battery assembly for providing power to electrical systems of the aircraft (10), wherein the battery assembly comprises a number of individual battery modules (18) which are directly or indirectly coupled to one another, the fuselage (12) is provided with a mounting assembly (16) with a number of mounting positions (16a, 16b, 16c) for each holding one of the battery modules (18), and the number of mounting positions (16a, 16b, 16c) is larger than the number of battery modules (18) such that in a mounted state of all battery modules (18), at least one of the mounting positions (16a, 16b, 16c) remains vacant (20) thus defining a placement configuration of the battery modules (18) and the vacant mounting positions (20), and/or the mounting assembly is provided with at least one displacement assembly which allows to displace at least one of the battery modules with respect to the fuselage.

The present invention relates to an aircraft, comprising a fuselage, at least one pair of wings and a battery assembly for providing power to electrical systems of the aircraft.

During the planning, design and development stages of aircrafts, the expected center of gravity of the aircraft can be calculated or at least estimated. However, due to tolerances in the exact dimensions and weights of the components employed for actually assembling the aircraft and due to unanticipated changes later on in the development, the center of gravity thereof may deviate from the targeted or expected center of gravity. Since the position of the center of gravity is of utmost importance, both directly and indirectly, for the stability, maneuverability and operability of an aircraft, being able to adjust said position within a certain range is an important factor during the latter stages of aircraft development programs in order to achieve the expected overall performance of the aircraft.

While conventional aircrafts with piston or jet engines are equipped with fuel tanks in which fuel can be reallocated in order to trim the corresponding aircraft, thus shifting its center of gravity, in electrically powered aircrafts such a procedure is not possible. Furthermore, small general aviation aircrafts sometimes also comprise trim weights, which can be used in operation to slightly alter the position of the center of gravity, since in said types of aircrafts, the operational center of gravity envelopes tend to be rather small. However, applying trim weights after the final assembly of an aircraft leads to additional weight and does not provide a wide range of center of gravity adjustment capabilities, either.

Thus, the techniques currently used for adjusting the center of gravity of aircrafts either rely on the reallocating of fuel between different tank units within the aircraft, add additional weight to the aircraft or narrow the center of gravity envelope in its operation.

It is therefore the object of the present invention to provide an aircraft, in which the center of gravity can be adjusted without the above-cited drawbacks of approaches known from the prior art, while relying on the battery assemblies which are present in all modern types of electric aircrafts for storing and providing power to electrical systems of the aircraft and in particular in electrical propulsion types thereof, in which due to the higher requirements concerning battery capacity, large and heavy battery assemblies are employed.

In order to solve the above-cited problem, the aircraft according to the present invention is constructed such that the battery assembly comprises a number of individual battery modules which are directly or indirectly coupled to one another and its fuselage is provided with a mounting assembly with a number of mounting positions for each holding one of the battery modules, and wherein the number of mounting positions is larger than the number of battery modules, such that in the mounted state of all battery modules, at least one of the mounting positions remains vacant, thus defining a placement configuration of the battery modules and the vacant mounting positions and/or wherein the mounting assembly is provided with at least one displacement assembly which allows to displace at least one of the battery modules with respect to the fuselage.

The present invention is thus based on the fact that high-capacity battery assemblies are usually not constructed monolithically, but comprise a number of individual battery modules, which in the configuration of an aircraft according to the present invention may be positioned according to different mounting positions in the mounting assembly located within the fuselage of the aircraft in order to adjust its center of gravity and/or wherein such a mounting assembly may comprise a displacement assembly for displacing the battery modules to suitable positions at which they can subsequently be fixed for the eventual operation of the aircraft.

While it is usually desired to have as large a battery capacity in the aircraft as possible, since in the aircraft according to the present invention the vacant mounting positions and/or the displacement assembly hardly add any additional weight to the aircraft, the benefits of being able to adjust the center of gravity of the aircraft by means of relocating the battery modules and thus where applicable indirectly also the vacant mounting positions within the mounting assembly can be achieved without any major drawbacks and with almost the same mass per unit of electrical capacity of the mounting assembly and battery modules combined as compared with a smaller mounting assembly, in which no vacant mounting positions or displacement assemblies are provided.

While in certain configurations of the aircraft according to the present invention it might be beneficial to have at least two different kinds of battery modules in order to increase flexibility of the dimensions of the mounting assembly which thus for example may comprise mounting positions with different dimensions at different locations with respect to the fuselage, in a particularly simple and flexible embodiment, all of the battery modules may be substantially identical at least with respect to their outer dimensions. Thus, all of the battery modules as well as the vacant mounting positions in such an embodiment are freely interchangeable, and maximum flexibility concerning the configuration of the battery modules within the mounting assembly is achieved.

While the layout or the positioning of the possible mounting positions in the mounting assembly can be chosen almost arbitrarily and for example the spacing between possible mounting positions can also be smaller than the dimensions of the individual battery modules, comparable to mounting racks for electrical components known in the art, which allow for a positioning of the components with a granularity smaller than the dimensions of the components, in another particularly simple embodiment, the mounting assembly may be arranged such that the spacing between the mounting positions substantially corresponds to the dimensions of the battery modules, thus defining individual slots for the battery modules in accordance with their dimensions, which can either be loaded with a battery module or can be vacant.

Additionally or alternatively, the mounting positions may be provided in at least two layers with respect to the vertical axis of the aircraft and/or in at least two rows with respect to the width axis of the aircraft and/or in at least two rows with respect to the longitudinal axis of the aircraft. Herein the vertical, width and longitudinal axes of the aircraft may correspond to the yaw, pitch and roll axes of the internal coordinate system of the aircraft, respectively.

In different embodiments of the present invention, the individual battery modules may be electrically connected to one another and to other systems of the aircraft in different manners, and in particular the battery modules may be directly interconnected with one another or the respective connections may be established via individual connections of each battery module to the mounting assembly. In both cases, at least one dummy module may be provided, preferably one dummy module per vacant mounting position. Herein, the at least one dummy module may comprise connection points identical to the battery modules as well as internal wiring in order to establish a coupling between neighboring battery modules or to the mounting assembly, depending on which of the above-discussed embodiments is realized in the particular aircraft. While the dummy modules could make use of a casing to resemble the battery modules and potentially facilitate their mounting in case this is favored in a particular embodiment, in order to further safe weight, in alternative embodiments they may also merely consist of the components necessary to bridge connections from one of the modules to the next, for example just two cables.

Thus, for example in configurations, in which all of the battery modules are connected in series, said dummy modules may act to provide the serial connection between its neighboring battery modules while not contributing to the overall voltage themselves in a way an actual battery module would while adding only minimal weight due to them not comprising any heavy interior components.

As mentioned above, alternatively or additionally to providing vacant mounting positions, the mounting assembly may be provided with at least one displacement assembly which in some embodiments of the present invention may in turn comprise at least one rail system with an extension in at least one direction along which a linear displacement of the at least one associated battery module is enabled such that the displaceable modules can be fixed in numerous different positions with respect to the fuselage thus again adjusting the center of gravity of the airplane. Herein, depending on the layout of the rail system and the connection of the battery modules thereto, the battery modules may be displaceable individually or in larger groups. Also, nested rails in the at least one rail systems may provide for multiple directions in which the battery modules can be displaced.

Additionally or alternatively, the at least one displacement assembly may comprise at least one bolt which is movable within a corresponding long-hole, wherein one of the at least one bolt and the respective long-hole is associated to a respective battery module while the other is associated to the fuselage of the aircraft, such that a linear displacement of the corresponding battery module is enabled, wherein the position of the battery module can be fixed by means of corresponding fixing means, such as for example a nut which can be screwed onto the respective at least one bolt. In such an embodiment, the respective at least one battery module can individually be adjusted with respect to its position, such that a high flexibility in adjusting the center of gravity of the aircraft is achieved.

Similarly, the at least one displacement assembly may comprise at least one bolt and a series of corresponding receiving apertures for receiving said bolt in a fixed manner, wherein one of the at least one bolt and the respective series of receiving apertures is associated to a respective battery module while the other is associated to the fuselage of the aircraft, such that a linear displacement of the corresponding battery module is enabled by selectively coupling the at least one bolt with one of the receiving apertures, such that the position adjustment of the respective battery module can be performed in discrete steps.

While in principle any type of aircraft may be provided with a battery assembly according to the present invention, and while further in principle no restrictions concerning the wing configuration or propulsion type thereof have to be made, aircrafts according to certain embodiments of the present invention may further comprise at least one additional pair of wings or canard wings, wherein an intended center of gravity of the aircraft may be positioned between the pairs of wings with respect to the longitudinal axis of the aircraft and/or the aircraft may be of the electrical propulsion type.

Additionally, the present invention relates to a method for installing the battery assembly in an aircraft according to the invention, comprising the steps of determining the center of gravity of the aircraft in a state, in which all of the battery modules are unmounted, determining a possible placement configuration of the battery modules and where applicable the vacant mounting positions, in which the resulting center of gravity of the aircraft fulfils at least one condition concerning a predetermined intended center of gravity of the aircraft, and mounting the battery modules in the mounting assembly according to the possible placement configuration. Thus, the mounting of the battery modules according to the possible placement configuration can relate to positioning them in certain well-defined mounting positions or in positions along the at least one displacement direction of the displacement assembly.

Therein, the possible placement configuration may for example demand that the center of gravity of the aircraft is within a given range in at least one dimension with respect to the internal coordinate system of the aircraft, such that a number of possible placement configurations may be conceivable per aircraft.

However, it might also be possible to determine an optimal placement configuration, in which the determined center of gravity is closest to the predetermined intended center of gravity according to at least one metric and to thus mount the battery modules in the mounting assembly according to the optimal placement configuration. In this embodiment, the at least one metric may be the distance between the center of gravity of the optimal placement configuration and the predetermined intended center of gravity in one or more dimensions, such that with an exact or heuristic algorithm the optimal placement configuration can be found among all possible or conceivable configurations.

Lastly, the possible placement configuration or the optimal placement configuration may have to fulfil at least one additional condition unrelated to the center of gravity of the aircraft, such as for example it may be required not to have two vacant mounting positions next to each other in the mounting assembly or that the first and last mounting position of the mounting assembly in each direction has to be occupied by a battery module in order to ensure correct interconnections among the battery modules and with the remaining electrical system of the aircraft.

Additional features and advantages of the present invention will become even clearer from the following description of an embodiment thereof if taken together with the accompanying figures, which show in particular:

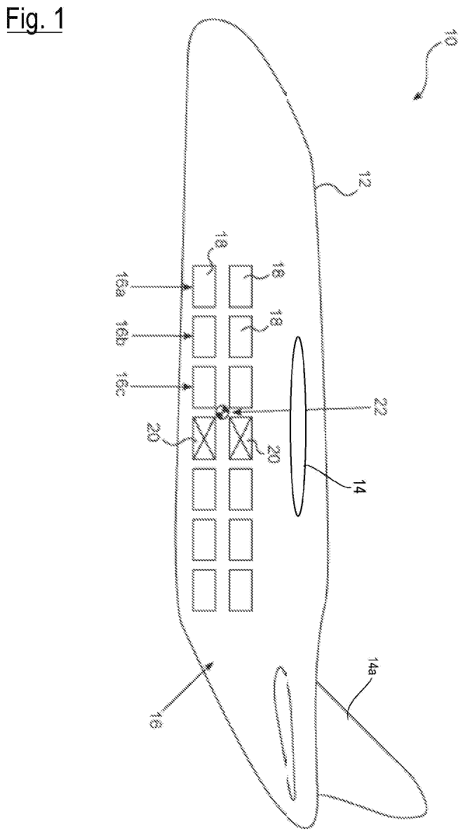

FIG. 1 a schematic view of an aircraft according to a first embodiment of the present invention;

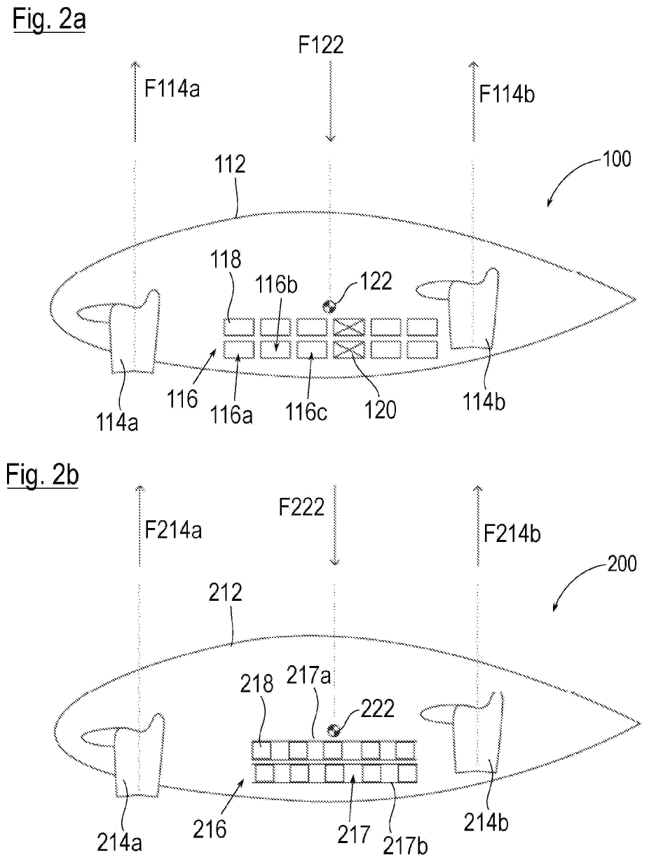

FIG. 2a and FIG. 2b two variations of an aircraft according to a second embodiment of the present invention in schematic cross-section views; and

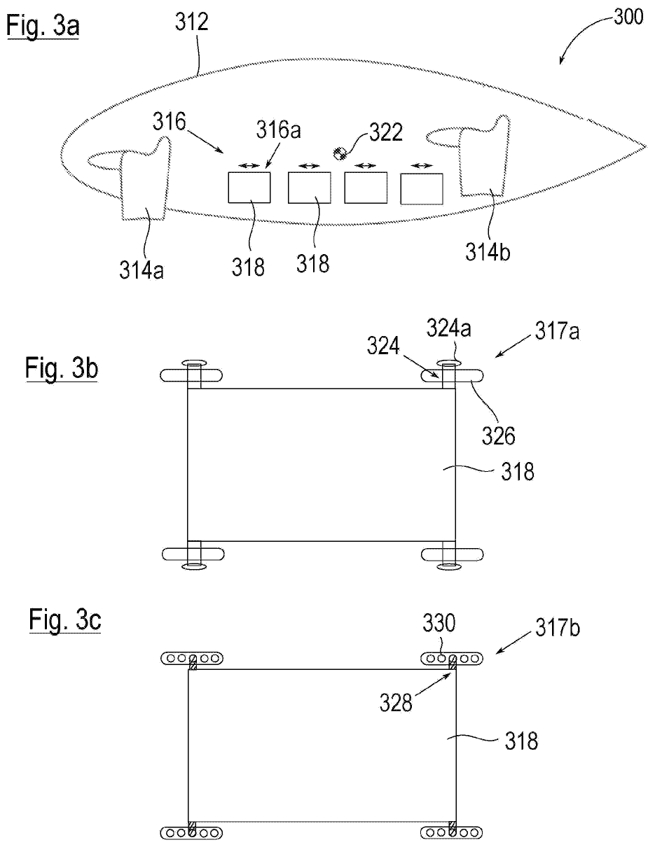

FIGS. 3a to 3c a third embodiment of an aircraft according to the present invention in a schematic cross-section view and two variations of displacement assemblies employable therein in schematic top views.

In FIG. 1, the aircraft according to the first embodiment of the present invention is generally referred to with reference numeral 10 and comprises a fuselage 12 as well as a pair of wings 14 and a tailplane/horizontal stabilizer 14a. While the embodiment of FIG. 1 is depicted with only a single pair of wings 14, in other embodiments of the present invention, the aircraft 10 may also comprise at least one additional pair of wings or canards as will be described below with reference to FIGS. 2a and 2b.

In the fuselage 12, a mounting assembly 16 is provided, which comprises a number of mounting positions 16a, 16b, 16c, . . . each adapted to hold one battery module 18. In the embodiment shown in FIG. 1, in the vertical direction two layers of mounting positions are provided, each comprising seven individual mounting positions along a row in the longitudinal direction of the aircraft 10, resulting in fourteen mounting positions. However, there are no restrictions on the number of mounting positions and their relative orientation in different embodiments of the invention.

On the other hand, only twelve battery modules 18 are provided, such that two of the mounting positions remain vacant. Said two vacant mounting positions are denoted with reference numeral 20 in FIG. 1. In order to adjust the center of gravity 22 of the aircraft 10 during its final assembly, the battery modules 18, which are all identical with respect to their outer dimensions, can be freely assigned to the fourteen available mounting positions of the mounting assembly 16, such that the vacant mounting positions 20 are positioned accordingly. Said vacant mounting positions 20 may be loaded with dummy modules with comprise connection points identical to the battery modules as well as internal wiring in order to establish a coupling between neighboring battery modules.

The present invention may thus be used to correct deviations between the intended center of gravity and the actual center of gravity of the aircraft 10 by mounting the battery modules 16a, 16b, 16c, . . . according to an optimal or at least a possible placement configuration which fulfils at least one condition concerning the predetermined intended center of gravity and possibly further at least one additional condition unrelated to the center of gravity of the aircraft.

Two variations of a second embodiment of an aircraft according to the present invention are further shown in FIGS. 2a and 2b and denoted with reference numerals 100 and 200, respectively. Therein, components which are similar or equivalent to the ones provided in the embodiment of FIG. 1 are denoted with the same reference numerals increased by 100 and 200 and the following description of the aircrafts 100 and 200 mainly concerns their differences to aircraft 10 while for the sake of brevity, for the description of similar or equivalent components thereof it is referred to the description of the corresponding components of aircraft 10 above.

One of the main differences between the aircraft 10 of FIG. 1 and the aircrafts 100, 200 of FIGS. 2a and 2b is that instead of a single pair of wings 14, two pairs of wings 114a, 114b and 214a, 214b are provided in each of them in order to facilitate vertical or at least short take-off and landing capabilities with engines providing thrust mounted on each wing in a rotatable manner with respect to the fuselage. In order to illustrate said capabilities, propulsion vectors F114a, F114b, F214a and F214b are shown, which counteract the gravitational forces F122, F222 acting on the respective centers of gravity 122, 222.

While the center of gravity of aircraft 100 of FIG. 2a can be adjusted between the pairs of wings 114a, 114b by means of the mounting assembly 116 in a similar manner as with the mounting assembly 16 of aircraft 10 of FIG. 1, in aircraft 200 a modified mounting assembly 216 is used, in which the battery modules 218 are not positioned in well-defined mounting positions but may be displaced along at least one direction. Therefore, said mounting assembly 216 comprises a displacement assembly 217, in turn comprising two rail systems 217a and 217b, which each allow for a displacement of the battery modules 218 along the longitudinal direction of airplane 200 and to lock them at predetermined positions in order to adjust the center of gravity 222.

As can be seen in FIG. 2b, the battery modules 218 associated with upper rail system 217a are displaced with respect to the battery modules 218 associated with the lower rail system 217b while the distances among the battery modules associated with each rail system 217a, 217b are kept substantially uniform, for example by means of spacer or connector elements. In further variations of the second embodiment, said distances may also be adjustable and/or the rail systems may also allow adjustments of the positions of the battery modules 218 in additional directions, such as along a width or vertical axis of the airplane 200.

An example embodiment of an aircraft similar to the one shown in FIG. 2b, yet with individually adjustable battery modules 318 is shown in FIG. 3a and denoted with reference numeral 300. With respect to its fuselage 312 and wings 314a, 314b as well as center of gravity 322, reference shall be made to the description of the embodiment of FIG. 2b, which equally applies for the embodiment of FIG. 3a.

The individual adjustability of the battery modules 318 in aircraft 300 is achieved by a mounting assembly 316 which comprises individual mounting positions 316a, each provided with a respective displacement assembly for the battery module 318 positioned therein, wherein reference is made to FIGS. 3b and 3c for two examples of such displacement assemblies 317a and 317b, which are both shown in schematic top views.

The displacement assembly 317a shown in FIG. 3b comprises four bolts 324 attached to the battery module 318 which are each movable within corresponding long-holes 326 which are associated to the fuselage 312 of the aircraft 300. Thus, a relative linear displacement is possible between the battery module 318 and the fuselage 312, wherein the desired position of the battery module can be fixed by means of corresponding fixing means, such as nuts 324a which can be screwed onto the bolts 324 and provide frictional connection with the long-holes 326.

Similarly, the displacement assembly 317b shown in FIG. 3c comprises four bolts 328 attached to the battery module 318, which can each be received in one of a series of five receiving apertures 330 associated to the fuselage 312 of the aircraft 300 in a fixed manner. By introducing the bolts 328 into corresponding receiving apertures 330, the relative position of the battery module 318 to the fuselage 312 can be fixed and the center of gravity of aircraft 300 can be adjusted.

1. An aircraft comprising a fuselage, at least one pair of wings and a battery assembly for providing power to electrical systems of the aircraft, wherein:
the battery assembly comprises a number of individual battery modules which are directly or indirectly coupled to one another;
the fuselage is provided with a mounting assembly with a number of mounting positions for each holding one of the battery modules;
and wherein
the number of mounting positions is larger than the number of battery modules such that in a mounted state of all battery modules, at least one of the mounting positions remains vacant thus defining a placement configuration of the battery modules and the vacant mounting positions; and/or
the mounting assembly is provided with at least one displacement assembly which allows to displace at least one of the battery modules with respect to the fuselage.

2. The aircraft according to claim 1, wherein: all of the battery modules are substantially identical at least with respect to their outer dimensions and/or main interfaces.

3. The aircraft according to claim 1, wherein:
the mounting assembly is arranged such that the spacing between the mounting positions substantially corresponds to the dimensions of the battery modules.

4. The aircraft according to claim 1, wherein:
the mounting positions are provided in at least two layers with respect to the vertical axis of the aircraft and/or in at least two rows with respect to the width axis of the aircraft and/or in at least two rows with respect to the longitudinal axis of the aircraft.

5. The aircraft according to claim 1, further comprising:
at least one dummy module per vacant mounting position.

6. The aircraft according to claim 1, wherein:
the at least one dummy module comprises connection points identical to the battery modules as well as internal wiring in order to establish coupling between neighboring battery modules.

7. The aircraft according to claim 1, wherein:
the at least one displacement assembly comprises at least one rail system with an extension in at least one direction along which a linear displacement of the at least one associated battery module is enabled.

8. The aircraft according to claim 1, wherein:
the at least one displacement assembly comprises at least one bolt which is movable within a corresponding long-hole, wherein one of the at least one bolt and the respective long-hole is associated to a respective battery module while the other is associated to the fuselage of the aircraft such that a linear displacement of the corresponding battery module is enabled, wherein the position of the battery module can be fixed by means of corresponding fixing means.

9. The aircraft according to claim 1, wherein:
the at least one displacement assembly comprises at least one bolt and a series of corresponding receiving apertures for receiving said bolt in a fixed manner, wherein one of the at least one bolt and the respective series of receiving apertures is associated to a respective battery module while the other is associated to the fuselage of the aircraft, such that a linear displacement of the corresponding battery module is enabled by selectively coupling the at least one bolt with one of the receiving apertures.

10. The aircraft according to claim 1, further comprising:
at least one additional pair of wings or canard wings, wherein an intended center of gravity of the aircraft is positioned between the pairs of wings with respect to the longitudinal axis of the aircraft.

11. The aircraft according to claim 1, wherein:
the aircraft is of the electrical propulsion type.

12. A method for installing the battery assembly in an aircraft according to claim 1, comprising the following steps:
determining the center of gravity of the aircraft in a state in which all of the battery modules are unmounted;
determining a possible placement configuration of the battery modules and where applicable the vacant mounting positions in which the resulting center of gravity of the aircraft fulfills at least one condition concerning a predetermined intended center of gravity; and
mounting the battery modules in the mounting assembly according to the possible placement configuration.

13. The method according to claim 9, further comprising the steps of:
determining an optimal placement configuration, in which the resulting center of gravity is closest to the predetermined intended center of gravity according to at least one metric; and
mounting the battery modules in the mounting assembly according to the optimal placement configuration.

14. The method according to claim 9, wherein:
the possible placement configuration or the optimal placement configuration has to fulfil at least one additional condition unrelated to the center of gravity of the aircraft.
